(19) United States
(12) Patent Application Publication
(10) Pub. No.: US 2026/0135273 A1
(43) Pub. Date: May 14, 2026

(54) SECONDARY BATTERY INCLUDING ELECTRODE TABS LATERALLY ARRANGED, AND METHOD OF MANUFACTURING THE SAME

(71) Applicant: SAMSUNG SDI CO., LTD., Yongin-si (KR)

(72) Inventors: Donghyun KIM, Yongin-si (KR); Yejin SEO, Yongin-si (KR); Eunjeong MOON, Yongin-si (KR)

(21) Appl. No.: 19/263,901

(22) Filed: Jul. 9, 2025

(30) Foreign Application Priority Data
Nov. 13, 2024 (KR) 10-2024-0161356

(51) Int. Cl. H01M 50/54; H01M 50/536

(52) U.S. Cl. CPC H01M 50/54; H01M 50/536

(57) ABSTRACT

A secondary battery includes electrode plates having a plurality of electrode tabs at different positions, an electrode assembly including a stack of the plurality of electrode plates, the plurality of electrode tabs being at different lateral positions of the electrode assembly, a strip conductor welded to the plurality of electrode tabs at the different lateral positions of the electrode assembly, and an external material accommodating the electrode assembly.

### CROSS-REFERENCE TO RELATED APPLICATION

The present application claims priority to and the benefit of Korean Patent Application No. 10-2024-0161356, filed on Nov. 13, 2024, in the Korean Intellectual Property Office, the entire disclosure of which is incorporated herein by reference.

### BACKGROUND

### 1. Field

The present disclosure relates to a secondary battery including electrode tabs laterally arranged and a method of manufacturing the same.

### 2. Description of the Related Art

Unlike primary batteries that cannot be recharged, secondary batteries are batteries that can be recharged. Low-capacity secondary batteries may be used in small portable electronic devices such as smartphones, feature phones, laptop computers, digital cameras, and camcorders, and high-capacity secondary batteries may be widely used as driving power sources and power storage batteries for motors in hybrid vehicles, electric vehicles, etc. A secondary battery includes an electrode assembly including a positive electrode plate and a negative electrode plate, an exterior material such as a case or can for accommodating the electrode assembly, and an external terminal electrically connected to the electrode assembly.

The above information disclosed in this Background section is for enhancement of understanding of the background of the present disclosure, and therefore, it may contain information that does not constitute a related (or prior) art.

### SUMMARY

Embodiments include a secondary battery, including a plurality of electrode plates including a plurality of electrode tabs at different positions, an electrode assembly including a stack of the plurality of electrode plates, the plurality of electrode tabs being at different lateral positions of the electrode assembly, a strip conductor welded to the plurality of electrode tabs at the different lateral positions of the electrode assembly, and an external material accommodating the electrode assembly.

The plurality of electrode tabs may not overlap each other in a stacking direction of the plurality of electrode plates.

The plurality of electrode tabs may be coplanar with each other.

The strip conductor may include a welding surface welded to the plurality of electrode tabs, and a protruding extension protruding from the welding surface, the protruding extension being electrically connected to an external conductor.

The welding surface may be welded to one surface of the plurality of electrode tabs.

The welding surface may be welded to each of one surface of the plurality of electrode tabs and a surface opposite to the one surface.

The secondary battery may further include an insulating film attached to the strip conductor.

At least one of the plurality of electrode tabs and the strip conductor may be bent.

The external material may be a pouch for a pouch-type secondary battery.

Embodiments include a method of manufacturing a secondary battery, the method including forming electrode tabs at different positions of a plurality of electrode plates, stacking the plurality of electrode plates, providing an electrode assembly, such that the electrode tabs are laterally arranged at different positions of the electrode assembly, resulting in laterally arranged electrode tabs, welding a strip conductor to the electrode tabs, and accommodating the electrode assembly in an external material.

In providing the electrode assembly, the plurality of electrode tabs do not overlap each other in a stacking direction of the plurality of electrode plates.

The method may further include shaping the plurality of electrode tabs to be coplanar with each other.

Welding the strip conductor may include welding the strip conductor to one surface of the laterally arranged electrode tabs.

Welding the strip conductor may include welding the strip conductor to one surface of the laterally arranged electrode tabs and a surface opposite to the one surface.

The method may further include attaching an insulating film to the strip conductor.

The method may further include bending at least one of an electrode tab of the plurality of electrode tabs and the strip conductor.

Accommodating the electrode assembly in the external material may include accommodating the electrode assembly in a pouch for a pouch-type secondary battery.

### BRIEF DESCRIPTION OF THE DRAWINGS

Features will become apparent to those of ordinary skill in the art by describing in detail exemplary embodiments with reference to the attached drawings, in which:

FIG. 1 schematically illustrates an electrode assembly of a secondary battery to which the present disclosure can be applied;

FIG. 2 is an exploded view of the electrode assembly shown in FIG. 1 and illustrates electrode plates constituting the electrode assembly;

FIG. 3 schematically illustrates a pouch-type secondary battery including the electrode assembly of FIG. 1;

FIG. 4 illustrates a weld of an electrode tab and a strip conductor of the electrode assembly of FIG. 1;

FIG. 5 illustrates electrode plates according to some embodiments of the present disclosure;

FIG. 6 is a front view of a state in which the electrode plates shown in FIG. 5 are stacked;

FIG. 7 is a perspective view of the stacked electrode plates shown in FIG. 6;

FIG. 8 illustrates a strip conductor welded to electrode tabs laterally arranged to form a weld according to some embodiments of the present disclosure;

FIG. 9 illustrates an electrode assembly according to some embodiments of the present disclosure;

FIG. 10 is a cross-sectional view of a secondary battery according to some embodiments of the present disclosure;

FIG. 11 illustrates a secondary battery for a comparative example; and

FIG. 12 illustrates another embodiment of a strip conductor.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

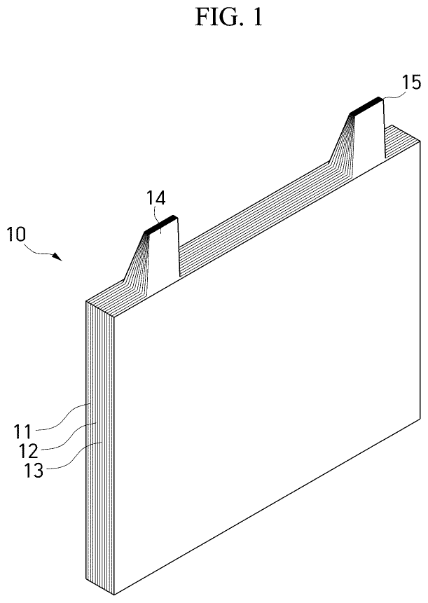

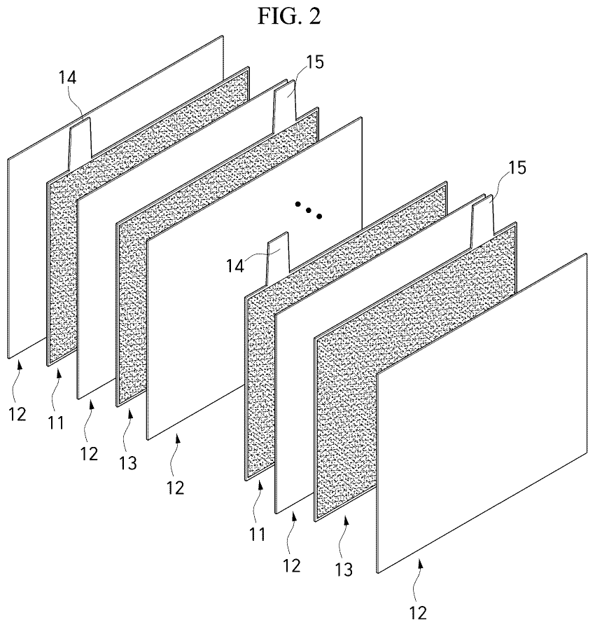

FIG. 1 is a schematic view of an example of an electrode assembly of a secondary battery and schematically illustrates a so-called stack-type electrode assembly. FIG. 2 is a schematic exploded view of the electrode assembly.

An electrode assembly 10 may be formed by stacking a stack of a first electrode plate 11, a separator 12, and a second electrode plate 13, each of which are formed as thin plates or films. In addition, the electrode assembly 10 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies may be stacked (e.g., arranged) such that long sides of the electrode assemblies are adjacent to each other and accommodated in a case, and the number of electrode assemblies in a case may vary. The first electrode plate 11 of the electrode assembly may act as a negative electrode, and the second electrode plate 13 may act as a positive electrode. Of course, the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

In some embodiments, the electrode assembly 10 may be accommodated in a case along with an electrolyte. In a pouch-type secondary battery, an electrode assembly 10 may be accommodated in a pouch made of flexible material. In a cylindrical or prismatic secondary battery, an electrode assembly 10 may be accommodated in a cylindrical or prismatic metal casing.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but the material(s) of the substrate may vary.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x≤2), a Si alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, Sno₂, Ceo₂, Mgo, Nio, Cao, Gao, Zno, Zro₂, Y₂o₃, Srtio₃, Batio₃, Mg(oh)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

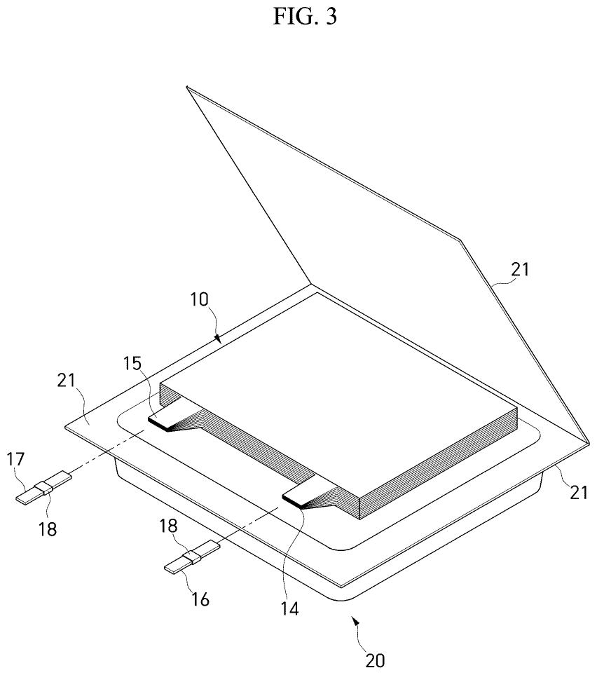

FIG. 3 schematically illustrates a pouch-type battery including the electrode assembly of FIG. 1.

The pouch-type secondary battery may be formed by accommodating an electrode assembly 10 in a pouch 20. A first electrode tab 14 and a second electrode tab 15 of the electrode assembly 10 as shown in FIG. 1 may be bonded and electrically connected to a first strip conductor 16 and a second strip conductor 17 which serve as terminals and are exposed to the outside, respectively. An insulating film 18 made of polypropylene (PP) for insulation with a pouch 20 and sealing may be attached to each of the first strip conductor 16 and the second strip conductor 17. Welding (e.g., ultrasonic welding) may be used to bond the first electrode tab 14 and the first strip conductor 16 and bond the second electrode tab 15 and the second strip conductor 17.

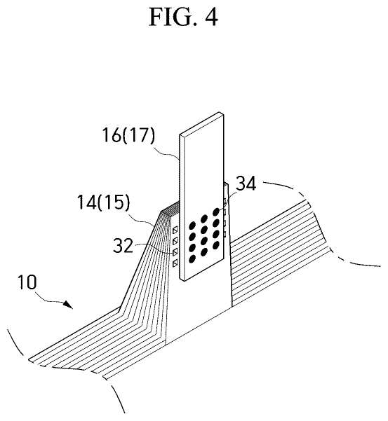

FIG. 4 illustrates a weld of a first electrode tab 14 or a second electrode tab 15 and a strip conductor 16 or 17 of the electrode assembly 10 shown in FIG. 1. A weld 32 formed between the first electrode tab 14 and the second electrode tab 15 formed on electrode plates constituting the electrode assembly 10 shown in FIG. 1 and a weld 34 formed by welding the strip conductor 16 or 17 to the first electrode tab 14 or second electrode tab 15 are shown. As shown, the first electrode tab 14 formed at the same position on the electrode plates should be welded, and the strip conductor 16 should be welded to the thick stack of first electrode tab 14. Various problems may arise in such a manufacturing method.

When ultrasonic welding is performed on a thick welded material on which a large number of first electrode tab 14 are stacked, welding quality may deteriorate. Since the large number of the first electrode tab 14 formed at the same position are thickly stacked to locally occupy a space, it is disadvantageous for space utilization, and thus energy density is reduced. In addition, when an electrode assembly is accommodated in an external material 21, an operation of bending the first electrode tab 14 and/or the strip conductor 16 may be made difficult, and space in a battery may be wasted due to an increase in space occupied after bending thereof, which may also be a cause of a decrease in energy density.

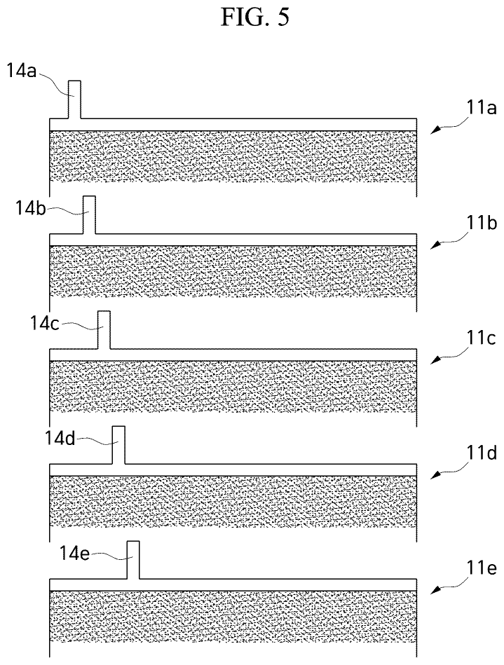

FIG. 5 illustrates electrode plates according to some embodiments of the present disclosure. For convenience of description and understanding, among electrode plates with two polarities, only electrode plates with one polarity are shown, and a separator has been omitted.

In FIG. 5, a first electrode tab 14a to a last electrode tab 14e are formed at different positions on first electrode plate 11a to the last electrode plate 11e, respectively. That is, with respect to the first electrode tab 14a of a first electrode plate 11a, the second electrode tab 14b of a second electrode plate 11b is formed at a position shifted from a position of the first electrode tab 14a (e.g., shifted to the right in the orientation shown). It is preferable that a position shift amount is set such that when the second electrode plate 11b is stacked on the first electrode plate 11a, there is no overlapping area between the second electrode tab 14b and the first electrode tab 14a. More preferably, the position shift amount is set such that when the second electrode plate 11b is stacked on the first electrode plate 11a, there is no large empty space between the second electrode tab 14b and the first electrode tab 14a. This is to minimize space occupied by the first electrode tab 14a to the last electrode tab 14e that are laterally arranged after all of first electrode plate 11a to the last electrode plate 11e have been stacked.

Similarly, the third electrode tab 14c of a third electrode plate 11c is formed at a position shifted from the position of the second electrode tab 14b. It is also preferable that a position shift amount is set such that when the third electrode plate 11c is stacked on the second electrode plate 11b, there is no overlapping area between the third electrode tab 14c and the second electrode tab 14b. More preferably, the position shift amount is set such that when the third electrode plate 11c is stacked on the second electrode plate 11b, there is no large empty space between the third electrode tab 14c and the second electrode tab 14b.

The last electrode tab 14e (or the fifth electrode tab) of the last electrode plate 11e is formed at a position shifted from a position of the fourth electrode tab 14d. It is also preferable that a position shift amount is set such that when the last electrode plate 11e is stacked on the fourth electrode plate 11d, there is no overlapping area between the last electrode tab 14e and the fourth electrode tab 14d. More preferably, the position shift amount is set such that when the last electrode plate 11e is stacked on the fourth electrode plate 11d, there is no large empty space between the fourth electrode tab 14d and the last electrode tab 14e.

In FIG. 5, only electrode plates having one polarity are shown, but electrode tabs may be formed at different positions on electrode plates having different polarities as described above.

FIG. 6 is a front view of a state in which the electrode plates shown in FIG. 5 are stacked.

As described above, when the first electrode plate 11a to the last electrode plate 11e on which the first electrode tab 14a to the last electrode tab 14e formed at different positions on the first electrode plate 11a to the last electrode plate 11e are stacked, the first electrode tab 14a to the last electrode tab 14e are laterally arranged at different positions on a stacked electrode assembly.

In addition, as described above, the first electrode tab 14a to the last electrode tab 14e are laterally arranged such that there is no overlapping area in a stacking direction of the first electrode plate 11a to the last electrode plate 11e.

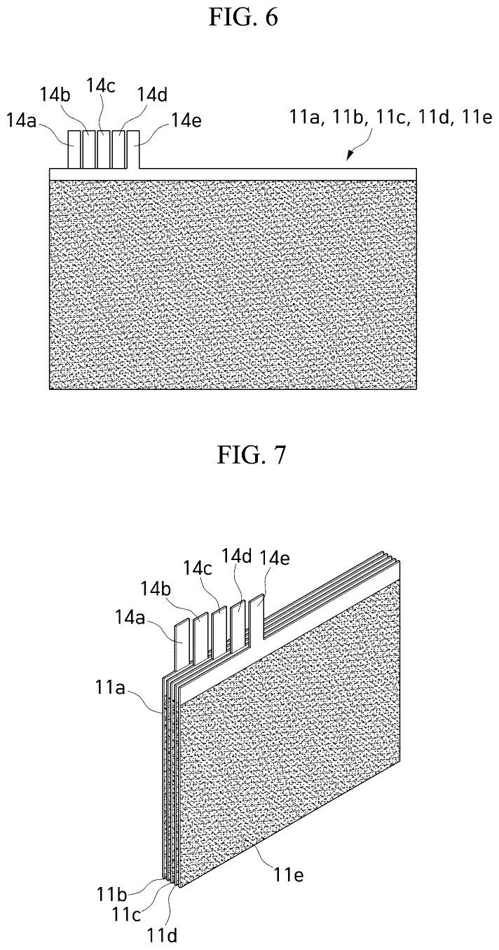

FIG. 7 is a perspective view of the stacked electrode plates shown in FIG. 6.

It can be seen that the first electrode tab 14a to the last electrode tab 14e do not overlap each other in a stacking direction of the first electrode plate 11a to the last electrode plate 11e but are laterally arranged and dispersed. In order to weld the strip conductor 16 to an array plane formed by the first electrode tab 14a to the last electrode tab 14e in a subsequent process, the first electrode tab 14a to the last electrode tab 14e may be shaped to be coplanar with each other. For example, the first electrode tab 14a to the last electrode tab 14e disposed at an outermost side and the second electrode tab 14b and the fourth electrode tab 14d disposed at an inner side with respect to the first electrode tab 14a and the last electrode tab 14e may be bent toward the third electrode tab 14c disposed at a middle area to shape the first electrode tab 14a to the last electrode tab 14e such that all of the first electrode tab 14a to the last electrode tab 14e are coplanar with each other.

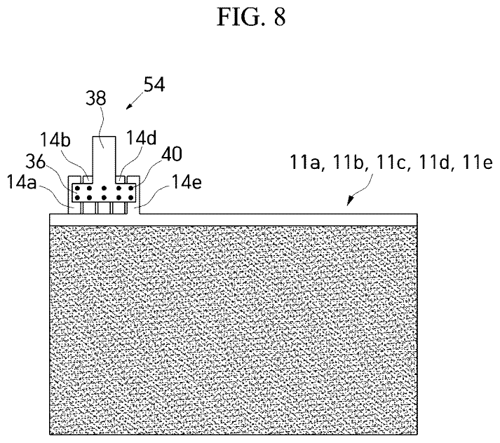

FIG. 8 illustrates that a strip conductor 54 is welded to first electrode tab 14a to the last electrode tab 14e laterally arranged to form a weld 40. As compared to a case in which the strip conductor 16 is welded to the thickly stacked multiples of electrode tab 14 as shown in FIG. 4, in the embodiment of the present disclosure, since the strip conductor 54 is welded to the first electrode tab 14a to the last electrode tab 14e that are laterally arranged and distributed to be practically coplanar with each other, there may be no electrode tabs omitted from welding, and welding may be performed with low-dose energy, thereby minimizing damage to a welded material and improving welding quality. In addition, when the first electrode tab 14a to the last electrode tab 14e need to be bent, ease of bending is made possible.

In some embodiments, the strip conductor 54 may include a welding surface 36 that approximately has a T shape and is welded to the first electrode tab 14a to the last electrode tab 14e (laterally arranged) and a protruding extension 38 that protrudes from the welding surface and is electrically connected to an external conductor.

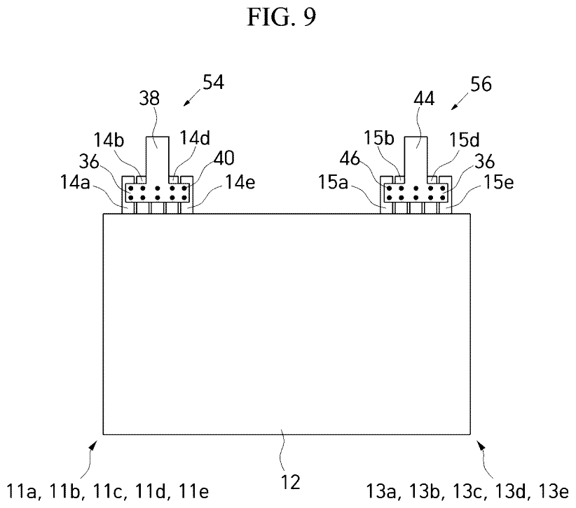

FIG. 9 illustrates an electrode assembly in which the embodiments of the present disclosure described above are applied to electrode plates at both sides (left and right sides in the orientation shown). The above-described first electrode plate 11a to the last electrode plate 11e, electrode plates 13a to 13e having different polarity therefrom, and a separator 12 are alternately stacked. Accordingly, there are first electrode tab 14a to the last electrode tab 14e having a first polarity, strip conductor 54, a weld 40 thereof, electrode tab 15a to electrode tab 15e having a second polarity, strip conductor 56, and a weld 46 thereof.

The electrode assembly manufactured in this manner may be accommodated in an external material such as a pouch to manufacture a secondary battery. In order to accommodate the electrode assembly in the external material, there may be a case in which the electrode tabs and/or the strip conductors need to be bent.

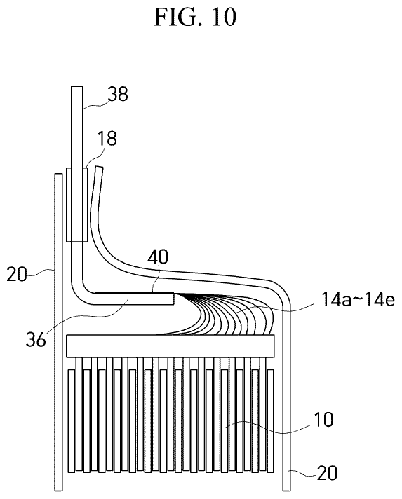

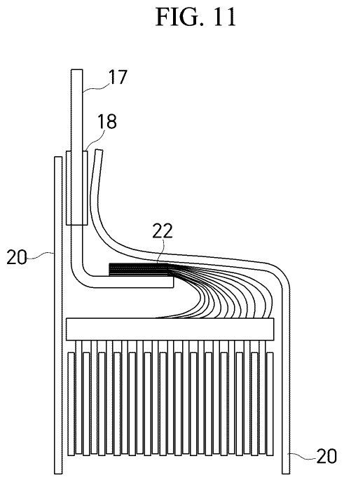

FIG. 10 is a cross-sectional view of a secondary battery according to some embodiments of the present disclosure. FIG. 10 illustrates an embodiment in which first electrode tab 14a to the last electrode tab 14e and a protruding extension 38 of a strip conductor 54 are bent as described above to accommodate an electrode assembly 10 in a pouch 20 in order to manufacture a secondary battery. It can be seen that a welding surface 36 of the strip conductor 54 and a weld 40 of the first electrode tab 14a to the last electrode tab 14e have thin surfaces. Since the first electrode tab 14a to the last electrode tab 14e are laterally arranged and distributed to be coplanar with each other, practically, the weld 40 is illustrated as an electrode tab with the same thickness as one electrode tab as shown in a side cross-sectional view of FIG. 10. Referring to FIG. 11 illustrating a secondary battery for a comparative example with FIG. 10, a weld 22 for electrode tabs, which are stacked to overlap each other, and a strip conductor 17 are illustrated as being thick.

In the embodiment of FIG. 10, an insulating film 18 for sealing and/or insulating a pouch 20 is attached to the protruding extension 38 of the strip conductor.

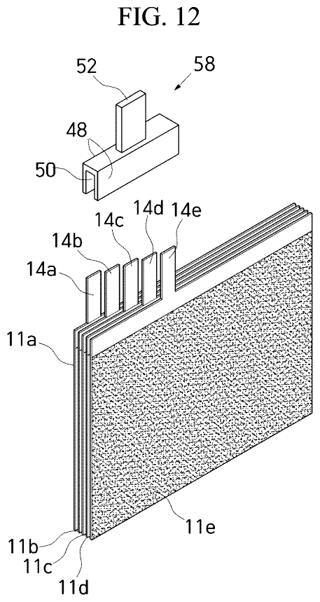

FIG. 12 illustrates another embodiment of a strip conductor.

The strip conductor 58 of FIG. 12 has welding surfaces 48 welded to both of one surface of first electrode tab 14a to the last electrode tab 14e (laterally arranged) and a surface opposite to the one surface. That is, there may be a space 50 between the welding surfaces 48 at both sides, and the first electrode tab 14a to the last electrode tab 14e are inserted into this space 50 so that both surfaces thereof may be welded. A protruding extension 52 is similar to that described with respect to FIG. 8.

In the case of types of stacked electrode tabs shown in FIG. 4, it is practically impossible to weld a strip conductor to both surfaces of the electrode tabs, but in the case of the first electrode tab 14a to the last electrode tab 14e laterally arranged to be coplanar with each other as shown in FIG. 12, a welding thickness is thin, and thus it is easy to weld the strip conductor to both surfaces. Through welding of both surfaces, it is possible to form a durable weld, reduce resistance at the weld, and obtain the effect of redundancy in which, even in the case of damage to a weld on one surface, a current flow in an electrode plate is not stopped due to a weld on the other surface.

Hereinafter, a method of manufacturing a secondary battery according to some embodiments of the present disclosure will be described. FIGS. 5 to 12 referenced in the above-described embodiments of a secondary battery are referenced for the following description of the method thereof.

The method of manufacturing a secondary battery according to some embodiments of the present disclosure includes forming first electrode tab 14a to the last electrode tab 14e at different positions on first electrode plate 11a to the last electrode plate 11e (see FIG. 5), stacking the first electrode plate 11a to the last electrode plate 11e on which the first electrode tab 14a to the last electrode tab 14e are formed at the different positions and providing an electrode assembly, wherein the electrode tabs are laterally arranged at different positions on the electrode assembly (see FIGS. 6 and 7), welding a strip conductor 54 to the first electrode tab 14a to the last electrode tab 14e laterally arranged at the different positions on the electrode assembly (see FIGS. 8 and 9), and accommodating the electrode assembly 10 in an external material 21 (see FIG. 10).

In some embodiments, in the providing of the electrode assembly, the plurality of electrode tab 14 may not have an overlapping area in a stacking direction of the plurality of electrode plates.

The method of manufacturing a secondary battery according to some embodiments of the present disclosure may additionally include shaping the plurality of electrode tabs to be coplanar with each other.

In some embodiments, the welding of the strip conductor may include welding the strip conductor to one surface of the laterally arranged electrode tabs. In some embodiments, the welding of the strip conductor may include welding the strip conductor to one surface of the laterally arranged electrode tabs and a surface opposite to the one surface.

The method of manufacturing a secondary battery according to some embodiments of the present disclosure may additionally include attaching an insulating film to the strip conductor.

In addition, the method of manufacturing a secondary battery according to some embodiments of the present disclosure may additionally include bending at least one of the electrode tabs and the strip conductor.

In some embodiments, the accommodating of the electrode assembly in the external material may include accommodating the electrode assembly in a pouch for a pouch-type secondary battery.

An electrode assembly and an external terminal may be electrically connected by welding a strip conductor to an electrode tab formed on an electrode plate constituting the electrode assembly. A plurality of electrode plates on which electrode tabs are formed may be stacked, and thus the stacked electrode tabs and a strip conductor may be welded. Ultrasonic welding may be used for welding the electrode tabs and welding the electrode tabs to the strip conductor. When an electrode assembly to which the strip conductor is welded is accommodated in an exterior material such as a pouch or a can, the welded electrode tabs and/or strip conductor may be bent.

According to the present disclosure, a strip conductor is welded to electrode tabs laterally distributed to be coplanar with each other without being welded to a thick welded material on which a large number of electrode tabs are stacked, thereby facilitating welding and improving welding quality. In addition, since the electrode tabs are not stacked in a thick manner, there may be advantages in terms of space utilization, and an increase in energy density can be achieved. Moreover, it is possible to easily bend electrode tabs and/or strip conductors, which may be necessary when an electrode assembly is accommodated in an external material.

Although the present disclosure has been described above with respect to embodiments thereof, various modifications and variations can be made thereto by those of ordinary skill in the art within the spirit of the present disclosure as defined by the appended claims and their equivalents. For example, a secondary battery and a method of manufacturing the same according to the embodiments of the present disclosure described above can also be applied to an electrode assembly used in a pouch-type battery of a different type from that of the pouch-type battery shown in FIG. 3 and other types of secondary batteries (for example, a prismatic secondary battery).

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the present invention as set forth in the following claims.

What is claimed is:

1. A secondary battery, comprising:
a plurality of electrode plates comprising a plurality of electrode tabs at different positions;
an electrode assembly including a stack of the plurality of electrode plates, the plurality of electrode tabs being at different lateral positions of the electrode assembly;
a strip conductor welded to the plurality of electrode tabs at the different lateral positions of the electrode assembly; and
an external material accommodating the electrode assembly.

2. The secondary battery as claimed in claim 1, wherein the plurality of electrode tabs do not overlap each other in a stacking direction of the plurality of electrode plates.

3. The secondary battery as claimed in claim 1, wherein the plurality of electrode tabs are coplanar with each other.

4. The secondary battery as claimed in claim 1, wherein the strip conductor comprises a welding surface welded to the plurality of electrode tabs, and a protruding extension protruding from the welding surface, the protruding extension being electrically connected to an external conductor.

5. The secondary battery as claimed in claim 4, wherein the welding surface is welded to one surface of the plurality of electrode tabs.

6. The secondary battery as claimed in claim 4, wherein the welding surface is welded to each of one surface of the plurality of electrode tabs and a surface opposite to the one surface.

7. The secondary battery as claimed in claim 1, further comprising an insulating film attached to the strip conductor.

8. The secondary battery as claimed in claim 1, wherein at least one of the plurality of electrode tabs and the strip conductor is bent.

9. The secondary battery as claimed in claim 1, wherein the external material is a pouch for a pouch-type secondary battery.

10. A method of manufacturing a secondary battery, the method comprising:
forming a plurality of electrode tabs at different positions of electrode plates;
stacking the electrode plates;
providing an electrode assembly, such that the plurality of electrode tabs are laterally arranged at different positions of the electrode assembly, resulting in laterally arranged electrode tabs;
welding a strip conductor to the plurality of electrode tabs; and
accommodating the electrode assembly in an external material.

11. The method as claimed in claim 10, wherein, in providing the electrode assembly, the plurality of electrode tabs do not overlap each other in a stacking direction of the plurality of electrode plates.

12. The method as claimed in claim 10, further comprising shaping the plurality of electrode tabs to be coplanar with each other.

13. The method as claimed in claim 10, wherein welding the strip conductor comprises welding the strip conductor to one surface of the laterally arranged electrode tabs.

14. The method as claimed in claim 10, wherein welding the strip conductor comprises welding the strip conductor to one surface of the laterally arranged electrode tabs and a surface opposite to the one surface.

15. The method as claimed in claim 10, further comprising attaching an insulating film to the strip conductor.

16. The method as claimed in claim 10, further comprising bending at least one of an electrode tab of the plurality of electrode tabs and the strip conductor.

17. The method as claimed in claim 10, wherein accommodating the electrode assembly in the external material comprises accommodating the electrode assembly in a pouch for a pouch-type secondary battery.
